(19) United States
(12) Patent Application Publication
(10) Pub. No.: US 2025/0363349 A1
(43) Pub. Date: Nov. 27, 2025

(54) SYSTEMS AND METHODS FOR MULTIVARIATE TIME SERIES FORECASTING

(71) Applicant: Salesforce, Inc., San Francisco, CA (US)

(72) Inventors: Juncheng Liu, San Francisco, CA (US); Gerald Woo, Singapore (SG); Chengao Liu, Singapore (SG); Doyen Sahoo, Singapore (SG)

(21) Appl. No.: 19/043,068

(22) Filed: Jan. 31, 2025

Related U.S. Application Data
(60) Provisional application No. 63/650,822, filed on May 22, 2024.

(51) Int. Cl. G06N 3/08

(52) U.S. Cl. CPC G06N 3/08

(57) ABSTRACT

Embodiments described herein provide A method of training a neural network based model for predicting time series data. The method may include receiving, via a data interface, multi-variate time-series data; generating a plurality of tokens based on flattening the multi-variate time-series data; generating a first intermediate representation via a first cross-attention layer of the neural network based model with a plurality of dispatcher tokens as the query, and the plurality of tokens as the key and value; generating a second intermediate representation via a second cross-attention layer of the neural network based model with the plurality of tokens as the query, and the first intermediate representation as the key and value; generating a predicted time-series value based on the second intermediate representation; computing a loss based on a comparison of the predicted time-series value and a ground-truth value; and training the neural network based model based on the loss.

### CROSS REFERENCE(S)

The instant application is a nonprovisional of and claim priority under 35 U.S.C. 119 to U.S. provisional application No. 63/650,822, filed May 22, 2024, which is hereby expressly incorporated by reference herein in its entirety.

### TECHNICAL FIELD

The embodiments relate generally to machine learning systems for Time series modeling, and more specifically to multivariate time series forecasting.

### BACKGROUND

Machine learning systems have been widely used in time series forecasting. However, existing models often fall short of capturing both intricate dependencies across channel and temporal dimensions in multivariate time series (MTS) data. Existing methods cannot directly and explicitly learn the intricate cross-channel and cross-time dependencies. Therefore, there is a need for improved models for multivariate time series forecasting.

### BRIEF DESCRIPTION OF THE DRAWINGS

FIG. 1 is a simplified diagram illustrating a multivariate time series forecasting framework according to some embodiments.

FIG. 2 illustrates exemplary correlation between two sub-series from different variates.

FIG. 3 illustrates exemplary correlation between patches from different variates.

FIG. 4A is a simplified diagram illustrating a computing device implementing the multivariate time series forecasting framework described in FIGS. 1-3, according to some embodiments.

FIG. 4B is a simplified diagram illustrating a neural network structure, according to some embodiments.

FIG. 5 is a simplified block diagram of a networked system suitable for implementing the multivariate time series forecasting framework described in FIGS. 1-3 and other embodiments described herein.

FIG. 6 is an example logic flow diagram illustrating a method of multivariate time series forecasting based on the framework shown in FIGS. 1-5, according to some embodiments.

FIGS. 7A-14 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

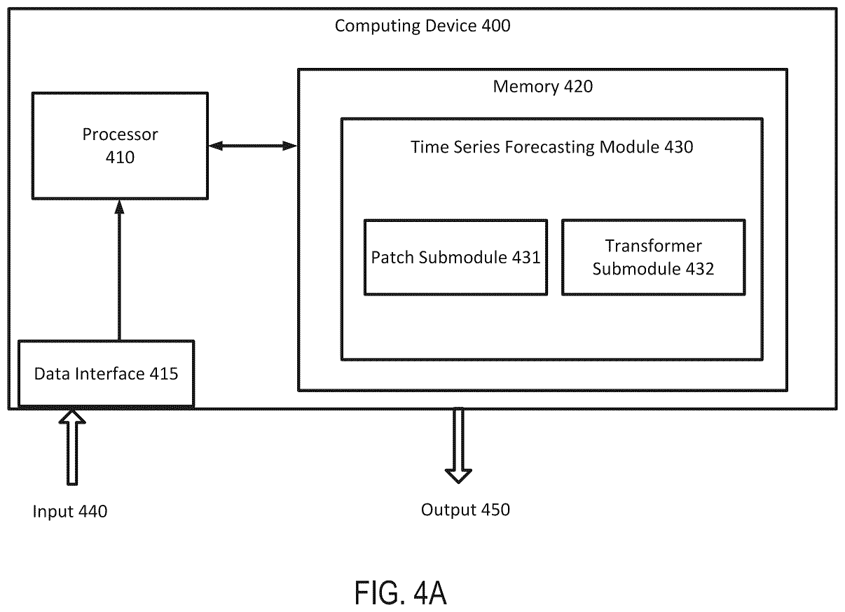

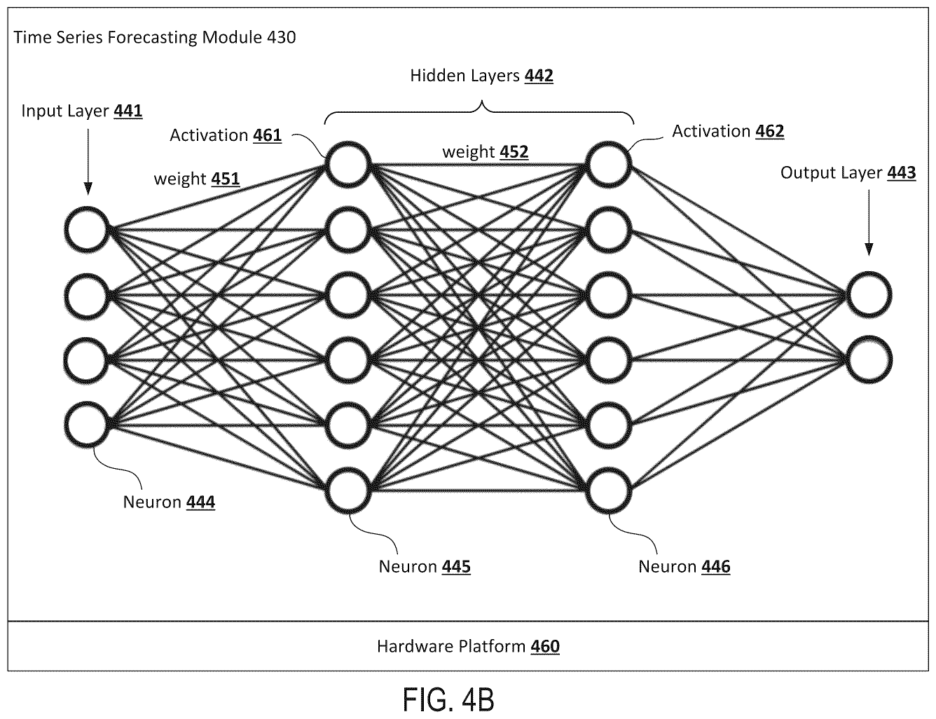

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 4B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

### Overview

Machine learning systems have been widely used in time series forecasting. However, existing models often fall short of capturing both intricate dependencies across channel and temporal dimensions in multivariate time series (MTS) data. Existing methods cannot directly and explicitly learn the intricate cross-channel and cross-time dependencies.

In view of the need for improved models for multivariate time series forecasting, embodiments described herein provide methods for directly modeling multi-variate dependencies. Embodiments include a transformer-based model containing a unified attention mechanism on flattened patch tokens (e.g., partitions of the time-series data). In some embodiments, a time series transformer with unified attention (UniTST) is used as a backbone for multivariate forecasting. Patches may be flattened from different variates into a unified sequence and the attention for inter-variate and intra-variate dependencies may be adopted simultaneously. Additionally, to mitigate the high memory cost associated with the flattening strategy, a dispatcher module may be utilized which reduces the complexity and makes the model feasible for a larger number of channels.

To mitigate the limitations of existing methods, embodiments herein provide a framework of multivariate time series transformers and a time series transformer with unified attention (UniTST) for multivariate forecasting. In some embodiments, all patches from different variates are flattened into a unified sequence and attention is computed for inter-variate and intra-variate dependencies simultaneously. To mitigate the high memory cost associated with the flattening strategy, in some embodiments the framework may further utilize a dispatcher mechanism to reduce complexity from quadratic to linear.

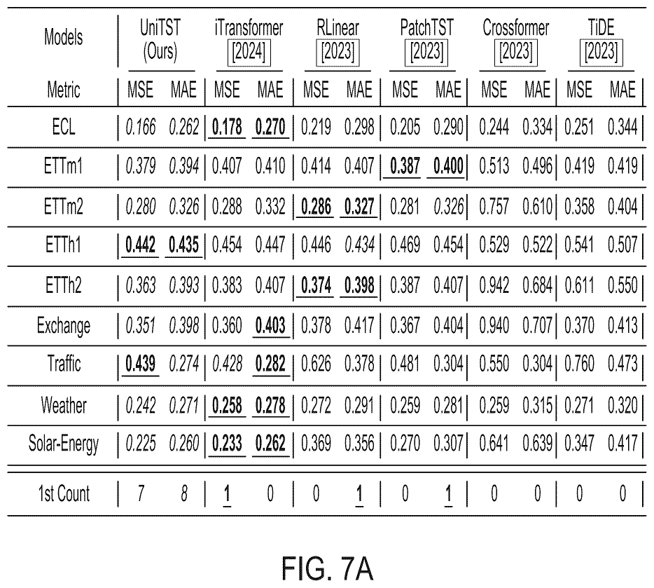

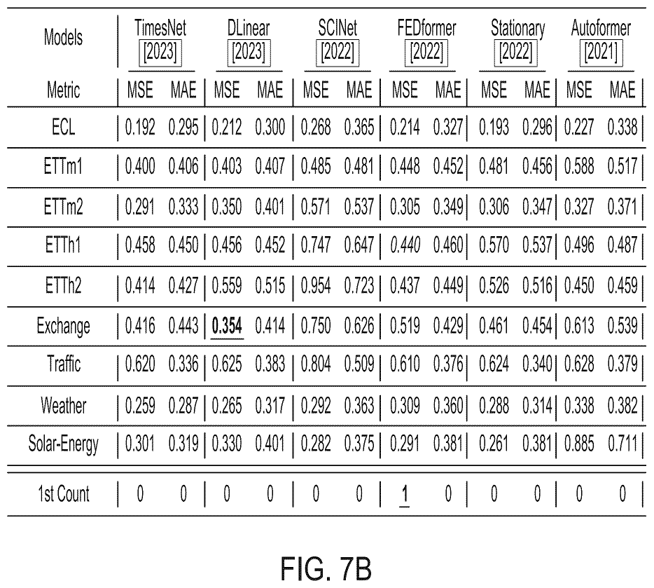

Embodiments described herein provide a number of benefits. For example, by providing an attention mechanism across inter-variate and intra-variate dependencies simultaneously, patterns across variates and across time may be learned, thereby providing more accurate model predictions. Embodiments herein provide a transformer for modeling multivariate time series data, which flattens all patches from different variates into a unified sequence to effectively capture inter-variate and intra-variate dependencies. As empirically demonstrated (e.g., in FIGS. 7A-14), embodiments herein achieve state-of-the-art performance on real-world benchmarks for both long-term and short-term forecasting with improvements up to 13%. Additional improvements over existing methods are described in FIGS. 7A-14. Therefore, with improved performance on multivariate time series forecasting, neural network technology in time series data modeling is improved.

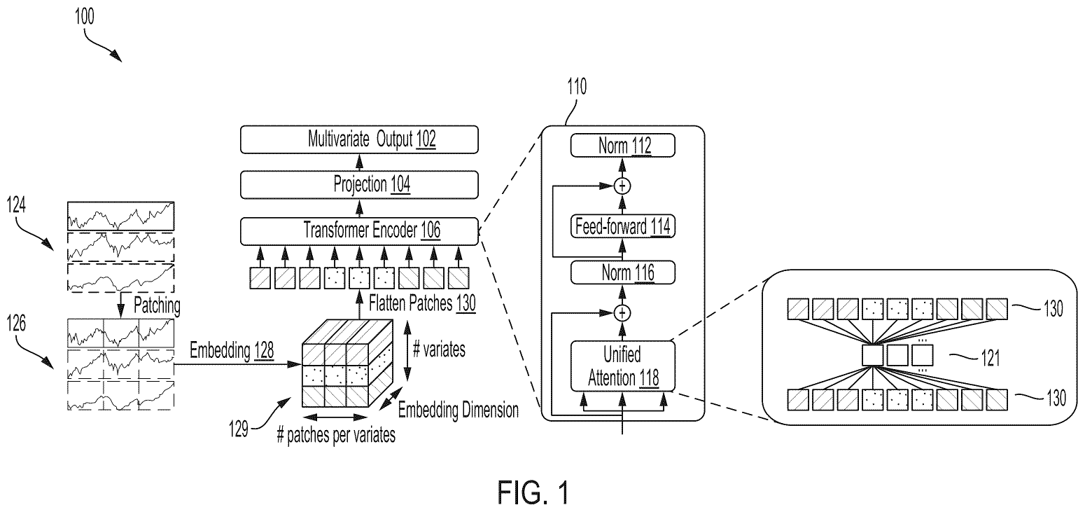

FIG. 1 is a simplified diagram illustrating a multivariate time series forecasting framework 100 according to some embodiments. The framework 100 divides each univariate time series of a set of multivariate time series data 124 into a number of patches 126 of predetermined length and stride. Patches 126 are embedded via a neural network based embedding model 128 into 2D token embeddings 129. The 2D token embedding matrix 129 is flattened into a 1D sequence of tokens 130. The 1D sequence of tokens 130 is used as the input to a transformer encoder 106 to generate an encoding. The encoding may be projected via projection 104 to provide a multivariate output 102, effectively predicting future time-series data beyond the input multivariate time series data 124. The flattened patches 130 allow for the attention mechanism to function across variates and across time (i.e., inter-variate and intra-variate) allowing for more accurate predictions.

In some embodiments, in order to mitigate the complexity of possible large number of variates (N), framework 100 may use a transformer encoder 106 with unified attention 118 which takes advantage of a dispatcher mechanism to aggregate and dispatch the dependencies among tokens 130.

In multivariate time series forecasting, given historical observations X_{:,t:t+L}∈ [symbol] ^{N×L} with L time steps and N variates, the task is to predict the future S time steps, i.e., X_{:,t+L+1:t+L+S}∈ [symbol] ^{N×L}. For convenience, X_{i,:}=_{X}_{⁽ⁱ⁾} may denote the whole time series of the i-th variate and X_{:,t} as the recorded time points of all variates at time step t.

To illustrate the diverse cross-time and cross-variate dependencies from real-world data, w following correlation coefficient between

$${x}_{t : t + L}^{( i )} and {x}_{t + L : t + 2 L}^{( i )}$$

may measure it. The cross-time cross-variate correlation coefficient may be defined as:

$${R}^{( i , j )} ( t , {t}^{′} , L ) = \frac{Cov ( {\times }_{t : t + L}^{( i )} , {\times }_{{t}^{′} : {t}^{′} + L}^{( j )} )}{{σ}^{( i )} {σ}^{( j )}} = \frac{1}{L} {\sum }_{k = 0}^{L} \frac{{\times }_{t + k}^{( i )} - {μ}^{( i )}}{{σ}^{( i )}} \cdot \frac{{\times }_{{t}^{′} + k}^{( i )} - {μ}^{( i )}}{{σ}^{( i )}} \qquad ( 1 )$$

where μ^{(·)} and σ^{(·)} are the mean and standard deviation of corresponding time series patches.

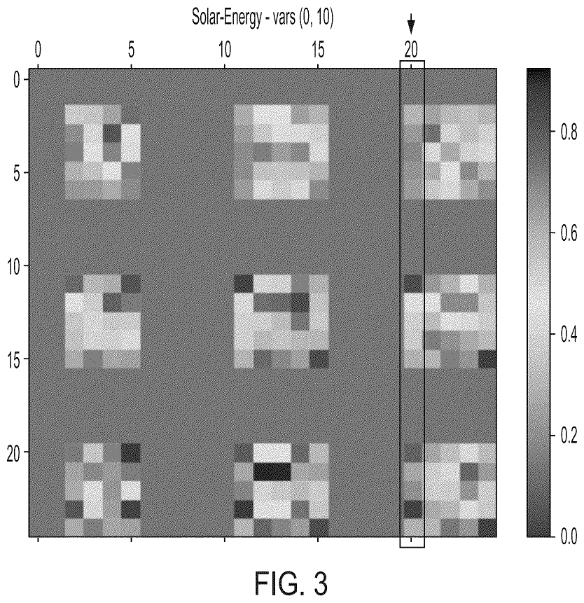

Utilizing the above correlation coefficient, one can quantify and further understand the diverse cross-time cross-variate correlation. The correlation coefficient between different time periods from two different variates is illustrated in FIG. 3.

Given the time series 124 with N variates X∈ [symbol] ^{N×T}, each univariate time series xⁱ may be divided into patches 126. With the patch length l and the stride s, for each variate i, a patch sequence

$${x}_{p}^{i} ∈ {ℝ}^{p \times l}$$

may be obtained where p is the number of patches Considering all variates, the tensor containing all patches is denoted as Xₚ∈ [symbol] ^{N×P×l}, where N is the number of variates. With each patch as a token, the 2D token embeddings 129 are generated using embedding 128 which may be a linear projection with position embeddings:

$$H = Embedding ( {X}_{p} ) = {X}_{p} W + {W}_{p o s} ∈ {ℝ}^{N \times p \times d} \qquad ( 2 )$$

where W∈ [symbol] ^{l×d} is the learnable projection matrix and Wₚₒₛ ∈ [symbol] ^{N×p×d} is the learnable position embeddings. With 2D token embeddings 129, H^{(i,k)} is the token embedding of the k-th patches in the i-th variate, resulting in N×p tokens.

Considering any two tokens, there are two relationships: 1) they are from the same variate; 2) they are from two different variates. These represent intra-variate and cross-variate dependencies, respectively. A desired model should have the ability to capture both types of dependencies, especially cross-variate dependencies. To capture both intra-variate and cross-variate dependencies among tokens, the 2D token embedding matrix 129 H is flattened into a 1D sequence with N×p tokens 130. This 1D sequence x′∈ [symbol] ^{(n×p)×d} is used as the input to a transformer encoder 106. The standard multi-head self-attention (MSA) mechanism may be applied directly to the 1D sequence:

$$O = MS A ( Q , K , V ) = Softmax ( \frac{Q {K}^{T}}{\sqrt{{d}_{k}}} ) V \qquad ( 3 )$$

with the query matrix Q=X′W_{Q}∈ [symbol] ^{(N×P)×d}^{ₖ}, the key matrix K=X′W_{K}∈ [symbol] ^{(N×P)×d}^{ₖ}, the value matrix V=X′W_{V}∈ [symbol] ^{(N×p)×d}, and W_{Q}, W_{K}∈ [symbol] ^{d×d}^{ₖ}, W_{V}∈ [symbol] ^{(d×d)}. The MSA helps the model to capture dependencies among all tokens, including both intra-variate and cross-variate dependencies. However, the MSA results in an attention map with the memory complexity of O(N²p²), which is very costly when there is a large number of variates N.

Framework 100 may add k (k<<N) learnable embeddings 121 as dispatchers and use cross attention to distribute the dependencies. The dispatchers aggregate the information from all tokens 130 by using the dispatcher embeddings 121 D as the query and the token embeddings 130 as the key and value:

$${D}^{′} = Attention ( {DW}_{{Q}_{1}} , {X}^{′} {W}_{{K}_{1}} , {X}^{′} {W}_{{V}_{1}} ) \qquad ( 4 )$$

where the complexity is O(kNp).

After that, the dispatchers 121 distribute the dependencies information to all tokens 130 by setting the token embeddings 130 as the query and the transformed (via the first cross-attention) dispatcher embeddings 121 as the key and value:

$${O}^{′} = Attention ( {X}^{′} {W}_{{Q}_{2}} , {D}^{′} {W}_{{K}_{1}} {D}^{′} {W}_{{V}_{1}} ) \qquad ( 5 )$$

where the complexity is O(kNq). The overall complexity of the dispatcher mechanism is lower than directly using self-attention on the flattened patch sequence which has complexity O(N²p²). This allows for fewer computation resources and/or memory to be required to achieve the high-performance results.

With the dispatcher mechanism, the dependencies between any two patches can be explicitly modeled through attention, no matter if they are from the same variate or different variates. In a transformer block 110, the output of attention is passed to a BatchNorm Layer 116 and a feedforward layer 114 with residual connections, which may be followed by another norm layer 112. After stacking several layers 110, the token representations are generated as Z^{N×D}. In the end, a linear projection 104 is used to generate the prediction 102 represented as \hat{X}∈R^{N×S}.

Training of the model (e.g., embedding parameters, cross-attention parameters including K, Q and V matrices, dispatch embedding parameters, projection 104, etc) may be performed via backpropagation utilizing a loss function. The loss function may be based on a comparison of multivariate output 102 to a ground truth multivariate time series (e.g., the continuation of a known multivariate time series, the beginning of which was input to the model). In some embodiments, a Mean-Squared Error (MSE) loss is used as the objective function to measure the different between the ground truth and the generated predictions:

$$ℒ = \frac{1}{N S} {\sum }_{i}^{N} {\hat{X}}^{( i )} - {X}_{{i , t + L + 1 : t + s )}^{2}} \qquad ( 6 )$$

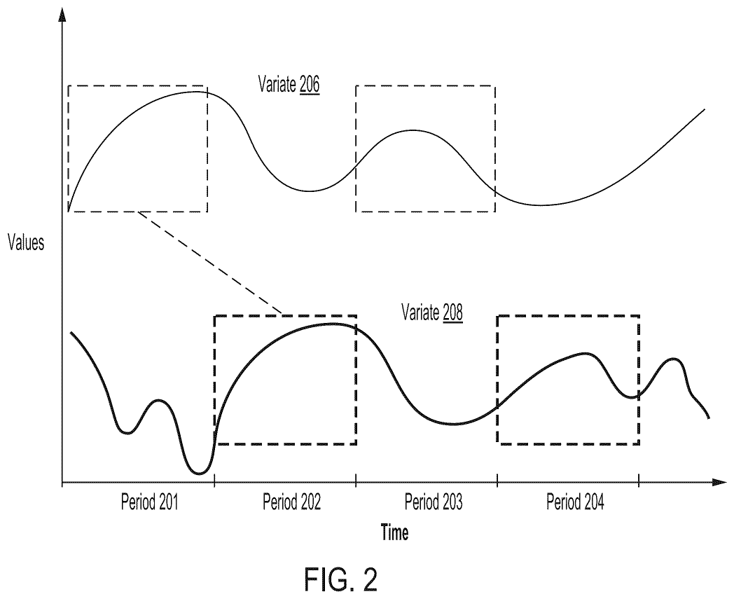

FIG. 2 illustrates exemplary correlation between two sub-series from different variates. As illustrated, the time series of variate 206 during period 201 shares the same trend with the time series of variate 208 during period 202. This type of correlation cannot be directly modeled by prior methods as it requires directly modeling cross-time cross-variate dependencies simultaneously. This type of correlation is important as it generally exists in real-world data.

FIG. 3 illustrates exemplary correlation between patches from different variates. The time series may be split into several patches and each patch denotes a time period containing a set number of time steps (e.g., 16). As illustrated in FIG. 3, given a pair of variates, the inter-variate dependencies are quite different for different patches. Looking at the column of Patch 20 in variate 10, it is strongly correlated with patch 3, 5, 11, 20, 24 of variate 0, while it is very weakly correlated with all other patches from variate 0. This suggests that there is no consistent correlation pattern for different patch pairs of two variates (i.e., not all the same coefficient at a row/column in the correlation map) and inter-variate dependencies are actually at the fine-grained patch level. Therefore, previous transformer-based models have a deficiency in directly capturing this kind of dependencies. The reason is that they either only capture the dependencies for the whole time series between two variates without considering the fine-grained temporal dependencies across different variates or use two separate attention mechanisms which are indirect and unable to explicitly learn these dependencies.

### Computer and Network Environment

FIG. 4A is a simplified diagram illustrating a computing device implementing the multivariate time series forecasting framework described in FIGS. 1-3, according to one embodiment described herein. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for time series forecasting module 430 that may be used to implement and/or emulate the systems and models, and/or to implement any of the methods described further herein. time series forecasting module 430 may receive input 440 such as an input training data (e.g., multivariate time series data) via the data interface 415 and generate an output 450 which may be predicted multivariate time series data.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as time series data, from a user via the user interface.

In some embodiments, the time series forecasting module 430 is configured to perform multivariate time series forecasting and/or training of a forecasting model as described herein. The time series forecasting module 430 may further include patch submodule 431. Patch submodule 431 may be configured to patch, embed the patches, and flatten patches of multivariate times series data as described herein. The time series forecasting module 430 may further include transformer submodule 432. Transformer submodule 432 may be configured to perform training and/or inference of a transformer model with a unified attention layer (e.g., via the use of dispatchers), as described herein.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 4B is a simplified diagram illustrating the neural network structure implementing the time series forecasting module 430 described in FIG. 4A, according to some embodiments. In some embodiments, the time series forecasting module 430 and/or one or more of its submodules 431-432 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as multivariate time series data. The number of nodes (neurons) in the input layer 441 may be determined by the dimensionality of the input data (e.g., the length of a vector of multivariate time series data). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4A, the time series forecasting module 430 receives an input 440 of multivariate time series data and transforms the input into an output 450 of forecasted time series data. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the time series forecasting module 430 and/or one or more of its submodules 431-432 may comprise the transformative neural network structure of layers of neurons, and weights and activation functions describing the non-linear transformation at each neuron. Such a neural network structure is often implemented on one or more hardware processors 410, such as a graphics processing unit (GPU).

In one embodiment, the time series forecasting module 430 and its submodules 431-432 may be implemented by hardware, software and/or a combination thereof. For example, the time series forecasting module 430 and its submodules 431-432 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

In one embodiment, the neural network based time series forecasting module 430 and one or more of its submodules 431-432 may be trained by iteratively updating the underlying parameters (e.g., weights 451, 452, etc., bias parameters and/or coefficients in the activation functions 461, 462 associated with neurons) of the neural network based on the loss described in Appendix I. For example, during forward propagation, the training data such as multivariate time series data are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding time series data) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

Parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen multivariate time series data, including data from unseen domains.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in time series forecasting.

In one embodiment, the time series forecasting module 430 and its submodules 431-432 may comprise one or more models built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., flattened patches of time-series data) using the encoder transformer. First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

In one embodiment, the time series forecasting module 430 and its submodules 431-432 may be implemented by hardware, software and/or a combination thereof. For example, the time series forecasting module 430 and its submodules 431-432 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the time series forecasting module 430 and its submodules 431-432 onto hardware platform 460, the neural network based modules 430 and its submodules 431-432 may be optimized for deployment by converting it to a suitable format, such as ONNX or TensorRT, to improve performance and compatibility. Next, depending on the size and workload requirements for modules 430 and its submodules 431-432, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the time series forecasting module 430 and its submodules 431-432 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the time series forecasting module 430 and its submodules 431-432 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the time series forecasting module 430 and its submodules 431-432 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the time series forecasting module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based time series forecasting module 430 and one or more of its submodules 431-432 may be trained by iteratively updating the underlying parameters (e.g., weights 451, 452, etc., bias parameters and/or coefficients in the activation functions 461, 462 associated with neurons) of the neural network based on the mean-squared error (MSE) loss described in equation (6). For example, during forward propagation, the training data such as time-series data are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding ground truth time-series data after the end of the input time-series data) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based time series forecasting module 430 and one or more of its submodules 431-432 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

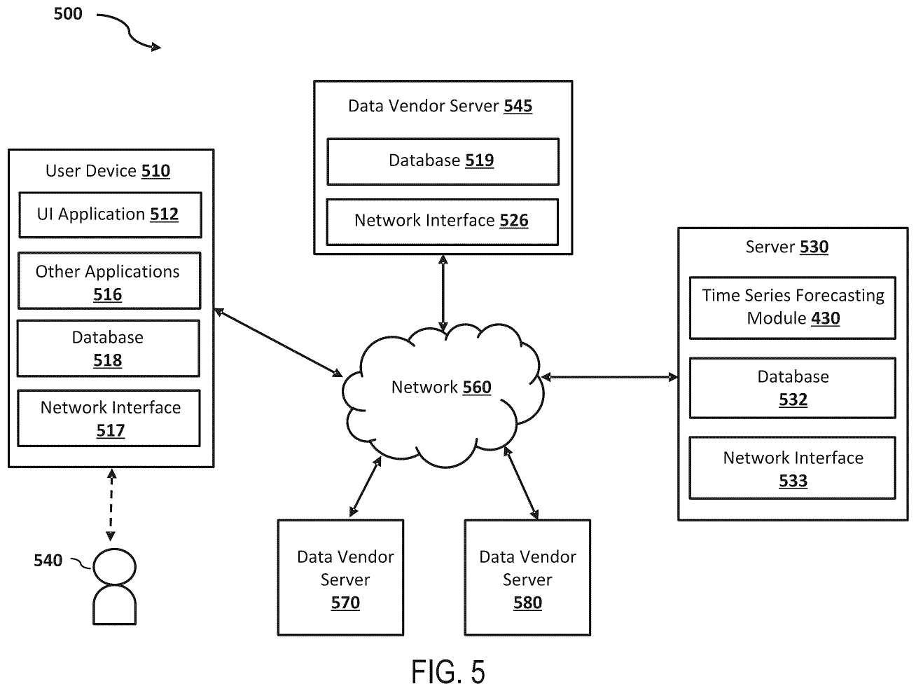

In some embodiments, time series forecasting module 430 and its submodules 431-432 may be housed at a centralized server (e.g., computing device 400) or one or more distributed servers. For example, one or more of time series forecasting module 430 and its submodules 431-432 may be housed at external server(s). The different modules may be communicatively coupled by building one or more connections through application programming interfaces (APIs) for each respective module. Additional network environment for the distributed servers hosting different modules and/or submodules may be discussed in FIG. 5.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen multivariate time-series data.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in multivariate time-series forecasting. Forecasting may be applied in contexts such as stock-market prediction, weather prediction, mechanical process prediction, etc.

FIG. 5 is a simplified block diagram of a networked system 500 suitable for implementing the multivariate time series forecasting framework described in FIGS. 1-3 and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating forecasted time series data from the server 530 and display the message via the UI application 512. In other embodiments, user device 510 may include additional or different modules having specialized hardware and/or software as required.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view forecasted time series data. For example, the GUI may receive user configured forecasting parameters such as forecast time window (e.g., next hour, next day, next 48 hours, etc.) and frequency (e.g., daily, hourly, weekly, etc.). In some embodiments, the GUI may comprise widgets for a user to select a past time window in order to select past time series for the prediction to rely on, and/or toe select a future window for prediction.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including multivariate time series data to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the time series forecasting module 430 and its submodules described in FIG. 4A. In some implementations, time series forecasting module 430 may receive data from database 519 at the data vendor server 545 via the network 560 to generate forecasted time series data. The generated time series data may also be sent to the user device 510 for review by the user 540 via the network 560.

The database 532 may be stored in a transitory and/or non-transitory memory of the server 530. In one implementation, the database 532 may store data obtained from the data vendor server 545. In one implementation, the database 532 may store parameters of the time series forecasting module 430. In one implementation, the database 532 may store previously generated time series data, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Work Flows

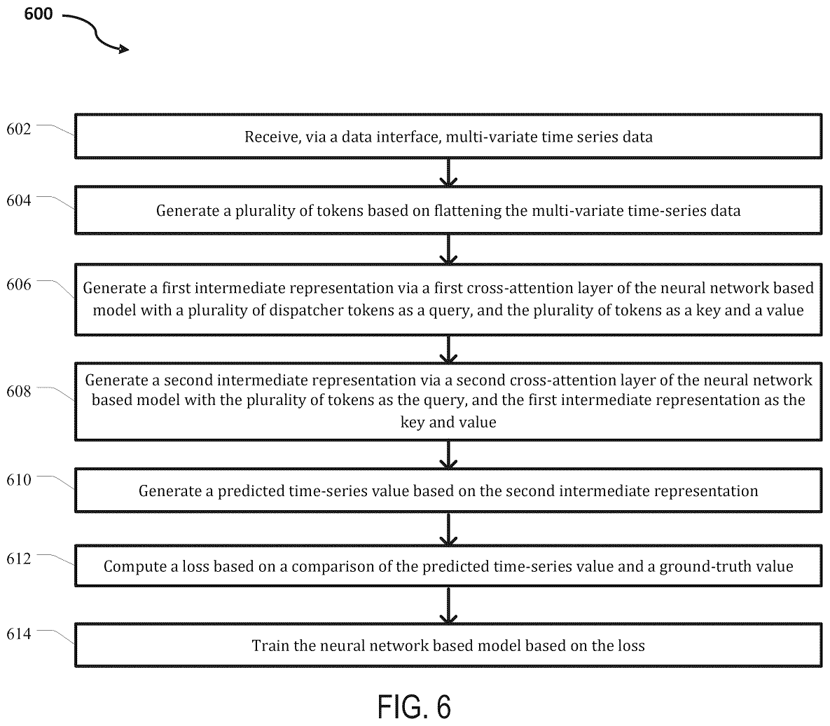

FIG. 6 is an example logic flow diagram illustrating a method 600 of multivariate time series forecasting based on the framework shown in FIGS. 1-5, according to some embodiments described herein. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the time series forecasting module 430 (e.g., FIGS. 4A and 5) that performs multivariate time series forecasting.

In some embodiments, method 600 is performed by a system such as computing device 400, user device 510, server 530, or another device or combination of devices. Inputs (e.g., multi-variate time-series data) may be received via a data interface such as data interface 415, network interface 517, network interface 533, or via a data interface that is integrated with a device. For example UI Application 512 may receive user inputs via a text input interface (e.g., keyboard), audio input (e.g., microphone), video interface (e.g., camera), or other interface for receiving user inputs (e.g., a mouse or touch display).

As illustrated, the method 600 includes a number of enumerated steps, but aspects of the method 600 may include additional steps before, after, and in between the enumerated steps. In some aspects, one or more of the enumerated steps may be omitted or performed in a different order.

At step 602, a system (e.g., computing device 400, user device 510, or server 530) receives, via a data interface (e.g., data interface 415, UI application 512, network interface 517, or network interface 533), multi-variate time series data (e.g., multi-variate time series data 124).

At step 604, the system generates a plurality of tokens (e.g., flattened patches 130) based on flattening the multi-variate time-series data. In some embodiments, the system separates the multi-variate time-series data into a plurality of patches (e.g., patches 126) and generates the plurality of tokens by encoding the plurality of patches (e.g., embeddings 129).

At step 606, the system generates a first intermediate representation via a first cross-attention layer of the neural network based model with a plurality of dispatcher tokens as a query, and the plurality of tokens as a key and a value. In some aspects, the system encodes the plurality of tokens via positional encoding, and the key and value are the encoded plurality of tokens. In some embodiments, the quantity of dispatcher tokens is fewer than the quantity of the plurality of tokens. For example, in some embodiments 5 dispatcher tokens are used, with many more tokens (e.g., hundreds).

At step 608, the system generates a second intermediate representation via a second cross-attention layer of the neural network based model with the plurality of tokens as the query, and the first intermediate representation as the key and value.

At step 610, the system generates a predicted time-series value based on the second intermediate representation. In some embodiments, additional layers of cross-attention with dispatcher tokens are included such that the output of one layer is the input of the next layer. For the case of multiple layers of cross-attention with dispatcher tokens, the output of the last layer may be used for the predicted time-series value.

At step 612, the system computes a loss based on a comparison of the predicted time-series value and a ground-truth value.

At step 614, the system trains the neural network based model based on the loss. In some embodiments, training the neural network based model includes updating the plurality of dispatcher tokens. For example, each dispatcher token may be a value or a vector of values, and the value(s) may be learned via the training process. In some embodiments, the loss is a mean squared error loss (e.g., equation (6)). In some aspects, training the neural network based model includes updating parameters of at least one of the first cross-attention layer or the second cross-attention layer according to the loss. For example, a query matrix, key matrix, and/or value matrix maybe updated for the first and/or second cross-attention layers.

In some embodiments, the system uses the trained model to make predictions of future behavior based on a multi-variate time-series input. For example, the neural network based model may be trained to predict a future network traffic pattern over a future period of time given network traffic pattern data during a past time period in a communication network. The system may allocate network bandwidths to different types of network traffic based on the predicted future network traffic pattern. In another example, motion sensors (e.g., accelerometers) may be mounted at various location on machinery (e.g., rotating machinery) to sense vibrations, and that collected data may be used as a multi-variate time series data input. Based on the vibration data, the trained model may make future predictions such as worsening machinery conditions. In another example, the multi-variate time series data input to the trained model may be the relative amounts of certain chemicals or mass signatures (e.g., from a mass spectrometer). Based on the input of chemical levels over time, the trained model may predict future changes which may be indicative of certain chemical processes. In another example, the input data may be various atmospheric conditions, which may be used by the trained model to predict those conditions over time, thereby predicting future weather conditions.

### Example Results

FIGS. 7A-14 represent exemplary test results using embodiments described herein. 11 well-known forecasting models were used as baselines. Transformer based baseline models include iTransformer as described in Liu et al., itransformer: Inverted transformers are effective for time series forecasting, ICLR, 2024; Crossformer as described in Zhang et al., Transformer utilizing cross-dimension dependency for multivariate time series forecasting, ICLR, 2023; FEDformer as described in Zhou et al., FEDformer: Frequency enhanced decomposed transformer for long-term series forecasting, ICML, 2022; Stationary as described in Liu et al., Non-stationary transformers: Rethinking the stationarity in time series forecasting, NeurIPS, 2022; and PatchTST as described in Nie et al., A time series is worth 64 words: Long-term forecasting with transformers, ICLR, 2023.

Linear-based baseline methods include DLinear as described in Zeng et al., Are transformers effective for time series forecasting? AAAI, 2023; RLinear as described in Li et al., Revisiting long-term time series forecasting: An investigation on linear mapping, arXiv:2305.10721, 2023; and TiDE as described in Das et al., Long-term forecasting with tide: Time-series dense encoder, arXiv:2304.08424, 2023.

Temporal Convolutional Network (TCN)-based methods used as baselines include TimesNet as described in Wu et al., Timesnet: Temporal 2d-variation modeling for general time series analysis, ICLR, 2023; and SCINet as described in Liu et al., SCINet: time series modeling and forecasting with sample convolution and interaction, NeurIPS, 2022.

FIGS. 7A-7B illustrate multivariate long-term forecasting results with prediction lengths of 96, 192, 335, and 720, with fixed lookback length of T=96. Results are averaged from all prediction lengths.

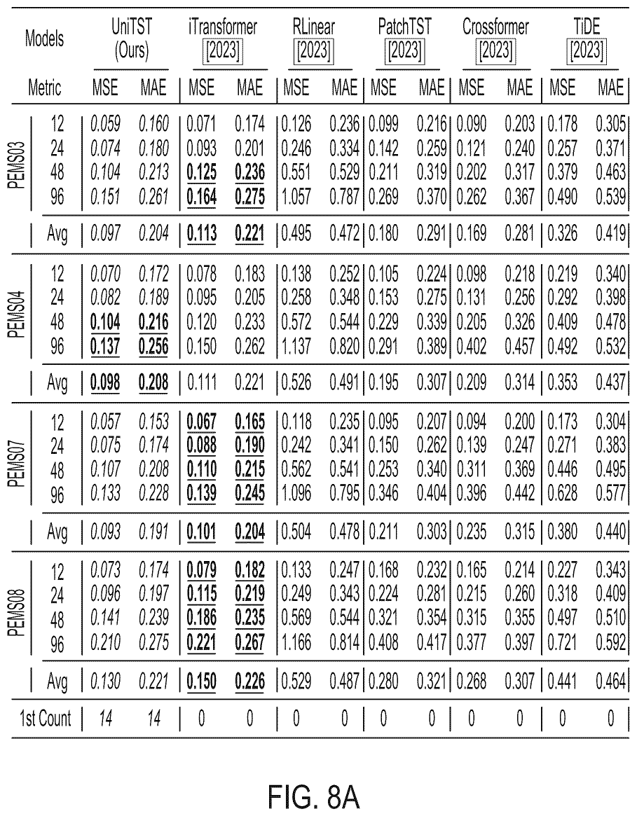

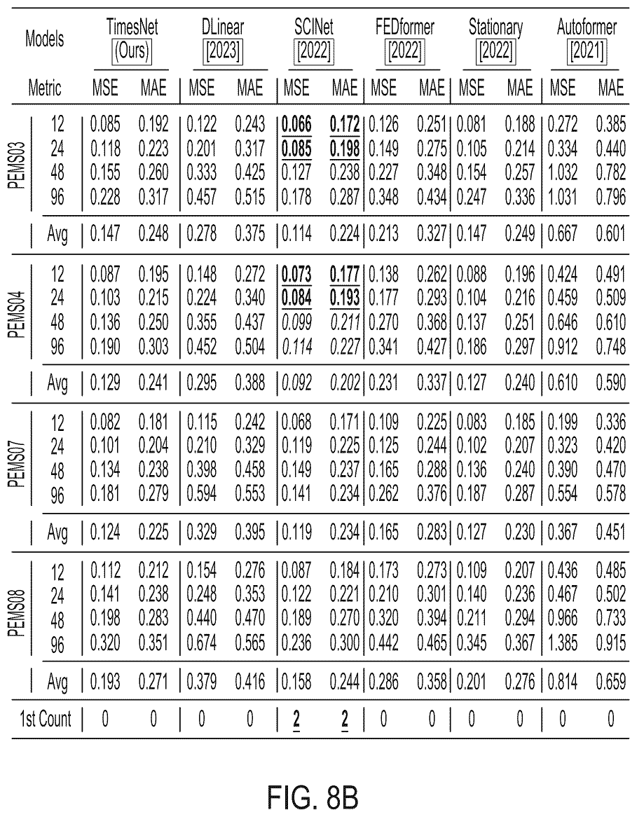

FIGS. 8A-8B illustrate full results of the PEMS forecasting task as described in as described in Liu et al., SCINet: time series modeling and forecasting with sample convolution and interaction, NeurIPS, 2022. Experiments compared extensive competitive models under different prediction lengths following the setting of SCINet. The input length was set to 96 for all baselines. Avg means the average results from all four prediction lengths.

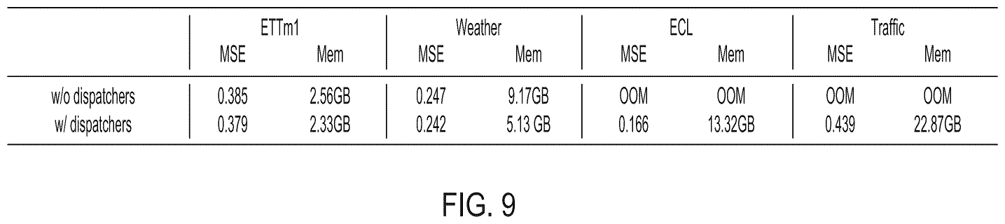

FIG. 9 illustrates the effectiveness of the dispatcher module. OOM indicates the “out of memory” error on GPUs (tested on a single A100 GPU of memory 40 GB). As illustrated, the use of dispatchers preserves memory resources.

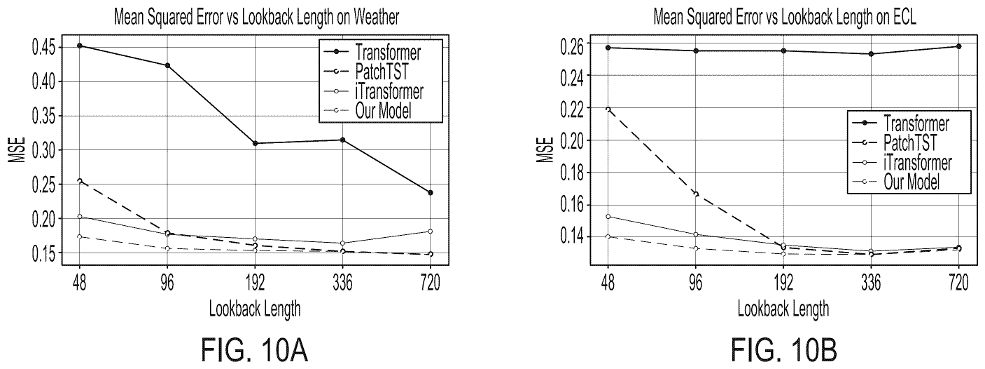

FIGS. 10A-10B illustrate performance with different lookback lengths and fixed prediction length S=96.

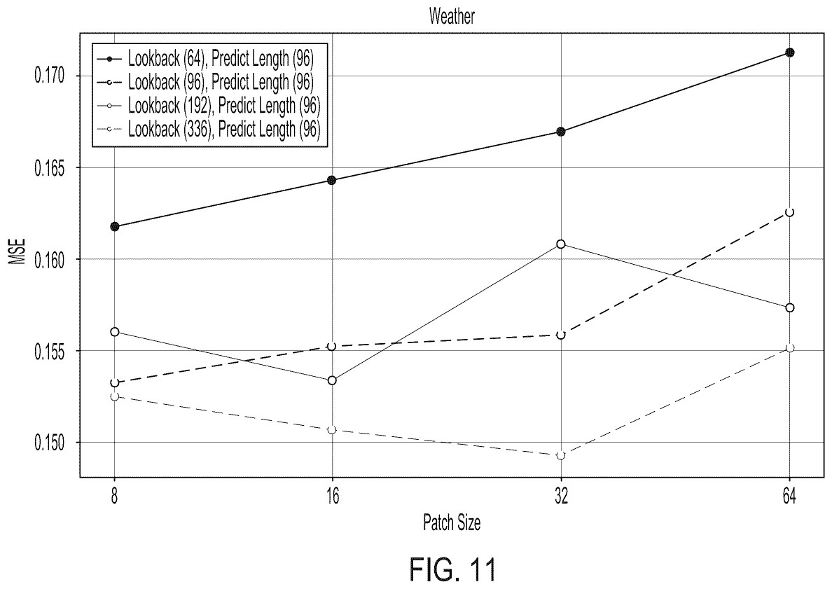

FIG. 11 illustrates performance with different patch sizes and lookback lengths.

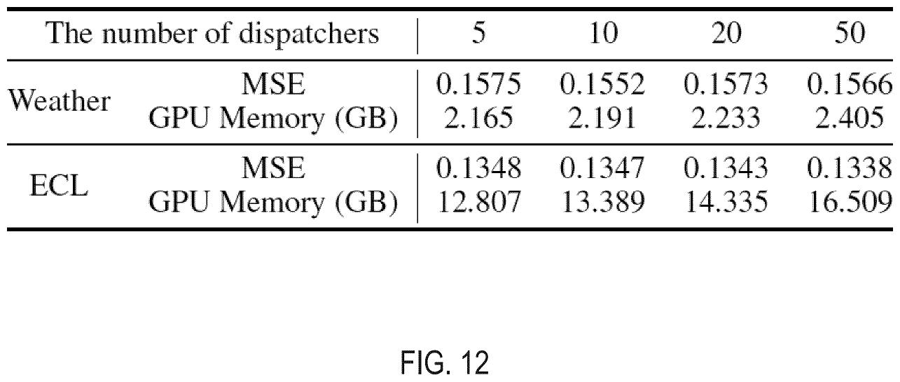

FIG. 12 illustrates the performance and GPU memory usage of varying dispatchers on Weather and ECL datasets.

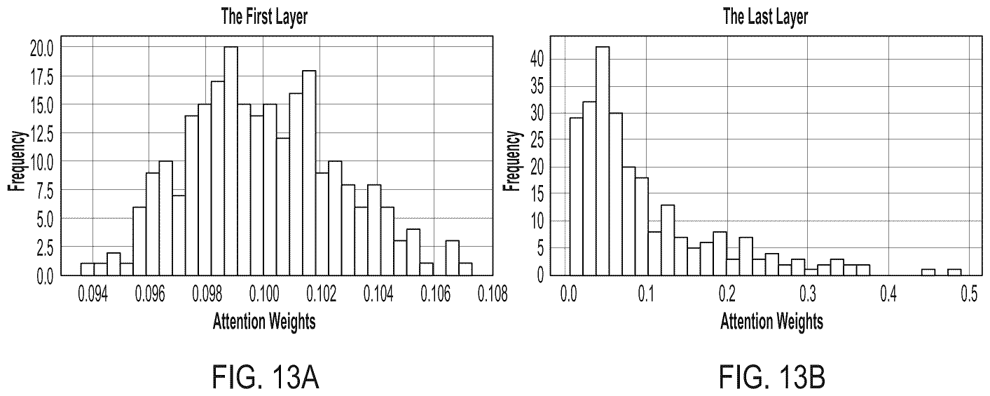

FIGS. 13A-13B illustrate the distribution of multiplied attention weights between two patch tokens on a Weather dataset.

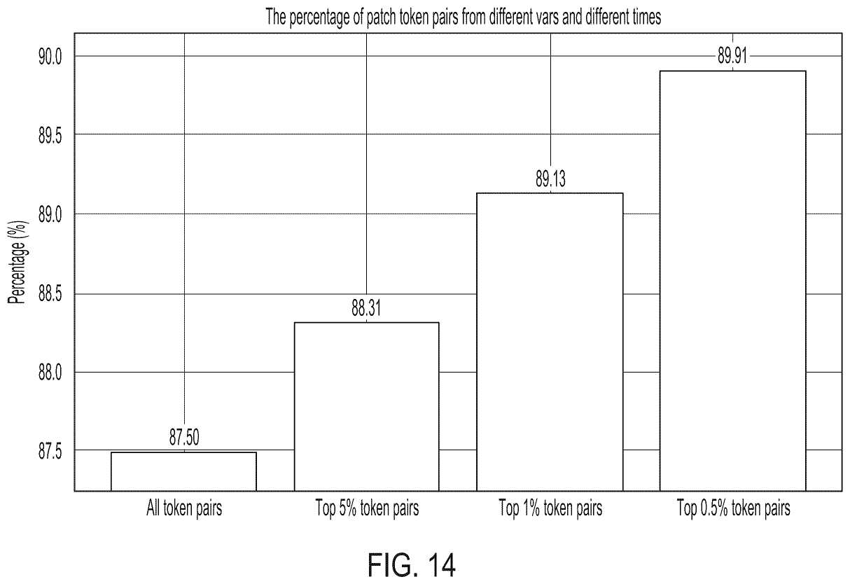

FIG. 14 illustrates the percentage of patch token pairs from different variates and different times. As illustrated, patch token pairs with higher top attention weights are more likely from different variates and different times.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of training a neural network based model for predicting time series data, the method comprising:
receiving, via a data interface, multi-variate time-series data;
generating a plurality of tokens based on flattening the multi-variate time-series data;
generating a first intermediate representation via a first cross-attention layer of the neural network based model with a plurality of dispatcher tokens as a query, and the plurality of tokens as a key and a value;
generating a second intermediate representation via a second cross-attention layer of the neural network based model with the plurality of tokens as the query, and the first intermediate representation as the key and value;
generating a predicted time-series value based on the second intermediate representation;
computing a loss based on a comparison of the predicted time-series value and a ground-truth value; and
training the neural network based model based on the loss.

2. The method of claim 1, wherein the neural network based model is trained to predict a future network traffic pattern over a future period of time given network traffic pattern data during a past time period in a communication network, and the method further comprises:
allocating network bandwidths to different types of network traffic based on the predicted future network traffic pattern.

3. The method of claim 1, further comprising:
separating the multi-variate time-series data into a plurality of patches; and
generating the plurality of tokens by encoding the plurality of patches.

4. The method of claim 3, further comprising:
encoding the plurality of tokens via a positional encoding, wherein the key and the value are the encoded plurality of tokens.

5. The method of claim 1, wherein training the neural network based model includes updating the plurality of dispatcher tokens.

6. The method of claim 1, wherein:
the loss is a mean squared error loss, and
training the neural network based model includes updating parameters of at least one of the first cross-attention layer or the second cross-attention layer according to the loss.

7. The method of claim 1, wherein a quantity of the plurality of dispatcher tokens is fewer than a quantity of the plurality of tokens.

8. A system for training a neural network based model for predicting time series data, the system comprising:
a memory that stores the neural network based model and a plurality of processor executable instructions;
a communication interface that receives multi-variate time-series data; and
one or more hardware processors that read and execute the plurality of processor-executable instructions from the memory to perform operations comprising:
generating a plurality of tokens based on flattening the multi-variate time-series data;
generating a first intermediate representation via a first cross-attention layer of the neural network based model with a plurality of dispatcher tokens as a query, and the plurality of tokens as a key and a value;
generating a second intermediate representation via a second cross-attention layer of the neural network based model with the plurality of tokens as the query, and the first intermediate representation as the key and value;
generating a predicted time-series value based on the second intermediate representation;
computing a loss based on a comparison of the predicted time-series value and a ground-truth value; and
training the neural network based model based on the loss.

9. The system of claim 8, wherein the neural network based model is trained to predict a future network traffic pattern over a future period of time given network traffic pattern data during a past time period in a communication network, and the one or more hardware processors are further configured to perform operations comprising:
allocating network bandwidths to different types of network traffic based on the predicted future network traffic pattern.

10. The system of claim 8, the one or more hardware processors further configured to perform operations comprising:
separating the multi-variate time-series data into a plurality of patches; and
generating the plurality of tokens by encoding the plurality of patches.

11. The system of claim 10, the one or more hardware processors further configured to perform operations comprising:
encoding the plurality of tokens via a positional encoding, wherein the key and the value are the encoded plurality of tokens.

12. The system of claim 8, wherein training the neural network based model includes updating the plurality of dispatcher tokens.

13. The system of claim 8, wherein:
the loss is a mean squared error loss, and
training the neural network based model includes updating parameters of at least one of the first cross-attention layer or the second cross-attention layer according to the loss.

14. The system of claim 8, wherein a quantity of the plurality of dispatcher tokens is fewer than a quantity of the plurality of tokens.

15. A non-transitory machine-readable medium comprising a plurality of machine-executable instructions which, when executed by one or more processors, are adapted to cause the one or more processors to perform operations comprising:
receiving, via a data interface, multi-variate time-series data;
generating a plurality of tokens based on flattening the multi-variate time-series data;
generating a first intermediate representation via a first cross-attention layer of a neural network based model with a plurality of dispatcher tokens as a query, and the plurality of tokens as a key and a value;
generating a second intermediate representation via a second cross-attention layer of the neural network based model with the plurality of tokens as the query, and the first intermediate representation as the key and value;
generating a predicted time-series value based on the second intermediate representation;
computing a loss based on a comparison of the predicted time-series value and a ground-truth value; and
training the neural network based model based on the loss.

16. The non-transitory machine-readable medium of claim 15, wherein the neural network based model is trained to predict a future network traffic pattern over a future period of time given network traffic pattern data during a past time period in a communication network, and the one or more processors are further adapted to cause the one or more processors to perform operations comprising:
allocating network bandwidths to different types of network traffic based on the predicted future network traffic pattern.

17. The non-transitory machine-readable medium of claim 15, wherein the one or more processors are further adapted to cause the one or more processors to perform operations comprising:
separating the multi-variate time-series data into a plurality of patches; and
generating the plurality of tokens by encoding the plurality of patches.

18. The non-transitory machine-readable medium of claim 17, wherein the one or more processors are further adapted to cause the one or more processors to perform operations comprising:
encoding the plurality of tokens via a positional encoding, wherein the key and the value are the encoded plurality of tokens.

19. The non-transitory machine-readable medium of claim 15, wherein:
training the neural network based model includes updating the plurality of dispatcher tokens, and
a quantity of the plurality of dispatcher tokens is fewer than a quantity of the plurality of tokens.

20. The non-transitory machine-readable medium of claim 15, wherein:
the loss is a mean squared error loss, and
training the neural network based model includes updating parameters of at least one of the first cross-attention layer or the second cross-attention layer according to the loss.
